(19) United States
(12) Patent Application Publication
(10) Pub. No.: US 2016/0103573 A1
(43) Pub. Date: Apr. 14, 2016

(54) SCALABLE AND TABBED USER INTERFACE

(71) Applicant: Timothy Charles Jones, Godmanchester (GB)

(72) Inventor: Timothy Charles Jones, Godmanchester (GB)

(73) Assignee: Google Inc., Mountain View, CA (US)

(21) Appl. No.: 13/527,456

(22) Filed: Jun. 19, 2012

(51) Int. Cl. G06F 3/0483; G06F 3/0484; G06F 3/0482

(52) U.S. Cl. CPC G06F 3/0483; G06F 3/0482; G06F 3/04842; G06F 3/04847

(57) ABSTRACT

System and methods of providing more space to present data in a graphical user interface which uses tabs, are presented. A GUI including a plurality of tabs in a first portion of the GUI and a tab adjustment element, is provided to the user. User input indicating an activation of the tab adjustment element is received. In response to the user input, the size of the first portion of the graphical user interface is modified, and the plurality of tabs is adjusted to fit within the modified size of the first portion of the GUI.

### TECHNICAL FIELD

Embodiments of the present invention relate to the user interfaces and, more particularly, to a scalable, tabbed user interface.

### BACKGROUND

The use of computing devices such as computers, smartphones, laptops computers, tablet computers, personal digital assistants (PDAs), cell phones, portable media players, etc, is now prevalent. Users may use computing devices to perform a variety of different tasks using a variety of different applications. For example, a user may user a word processing application to draft a document, a browser application to view a webpage, a media player application to view media, etc. Each of these applications may provide a graphical user interface (GUI) to facilitate user input and to present data to the user. These GUIs may use tabs to present data in a more organized fashion.

Many mobile computing devices (e.g., cell phones, smartphones, personal digital assistants (PDAs), or tablet devices) may have smaller screen space (e.g., smaller screens) than desktop computing devices. The applications which are used on desktop computing devices may also be used on mobile computing devices. Because mobile devices may have smaller screens, there may be less screen space available to display data and/or information to the user. The screen space used to display the tabs used in the GUIs of applications decreases the amount of screen space on the mobile devices which may be used to present data and/or other information to the user.

### SUMMARY

In one embodiment, a method of adjusting tabs provided by a GUI is presented. A GUI may include a plurality of tabs in a first portion of the GUI and a tab adjustment element. In response to receiving user input indicating an activation of the tab adjustment element, a size of the first portion of the GUI is adjusted and the plurality of tabs are readjusted to fit within the modified size of the first portion of the GUI. One of the plurality of tabs may be a selected tab which is positioned and/or sized such that the data presented in the selected tab is not obscured when the first portion is minimized.

In another embodiment, another method of adjusting tabs provided by a GUI is presented. A GUI may include a file menu having a plurality of tabs and a file menu adjustment element. In response to user input indicating an activation of the file menu adjustment element, a size of the file menu is modified and the plurality of tabs are adjusted to fit within the modified size of the file menu.

In additional embodiments, computing devices for performing the operations of the above described embodiments are also implemented. Additionally, in embodiments of the invention, a computer readable storage media may store instructions for performing the operations of the embodiments described herein.

### BRIEF DESCRIPTION OF THE DRAWINGS

The present invention will be understood more fully from the detailed description given below and from the accompanying drawings of various embodiments of the invention.

FIG. 1 illustrates an exemplary system architecture, in accordance with one embodiment of the present invention.

FIG. 2A is an exemplary graphical user interface (GUI) in accordance with one embodiment of the present invention.

FIG. 2B is an exemplary GUI in accordance with another embodiment of the present invention.

FIG. 2C is an exemplary GUI in accordance with a further embodiment of the present invention.

FIG. 2D is an exemplary GUI in accordance with another embodiment of the present invention.

FIG. 3A is an exemplary GUI in accordance with one embodiment of the present invention.

FIG. 3B is an exemplary GUI in accordance with another embodiment of the present invention.

FIG. 4 is a flow diagram illustrating one embodiment for a method of adjusting tabs provided by a GUI.

FIG. 5 is a flow diagram illustrating another embodiment for a method of adjusting tabs provided by a GUI.

FIG. 6 is a block diagram of an exemplary computer system that may perform one or more of the operations described herein.

### DETAILED DESCRIPTION

Embodiments of the invention pertain to user devices that provide a GUI with tabs and context data associated with the tabs. The GUI may include multiple tabs presented in a first portion of the GUI and context data (e.g., functions, actions, options, settings, and/or content) associated with the tabs and presented in a second portion of the GUI. The GUI may also include an adjustment element (e.g., a handle) which allows a user to modify the size of the first and/or second portion of the GUI and to adjust (e.g., resize and/or reposition) the tabs to fit within the modified size of the first portion. When a user selects one of the tabs, the selected tab is resized to provide an unobscured view of the data (e.g., the name of the tab) within the selected tab.

Embodiments of the invention also pertain to user devices that provide a GUI using the menu bar. Menu items of the menu bar are presented as tabs in the first portion of the GUI and the context data associated with the tabs (e.g., the menu list for menu items) is presented in the second portion of the GUI. The GUI may also include an adjustment element (e.g., a handle) which allows a user to adjust the size of the first and/or second portion of the GUI. One of the tabs may be selected by the user and the selected tab may be highlighted. The data presented by the selected tab (e.g., the name of the menu item) is not obscured by the other tabs when the size of the first portion is adjusted.

Embodiments of the invention provide a mechanism for displaying multiple tabs within a GUI and presenting data associated with the tabs while reducing the amount of screen space occupied by the tabs. This mechanism is especially useful for computing devices that have smaller screen space for displaying data (e.g., mobile phones and tablets).

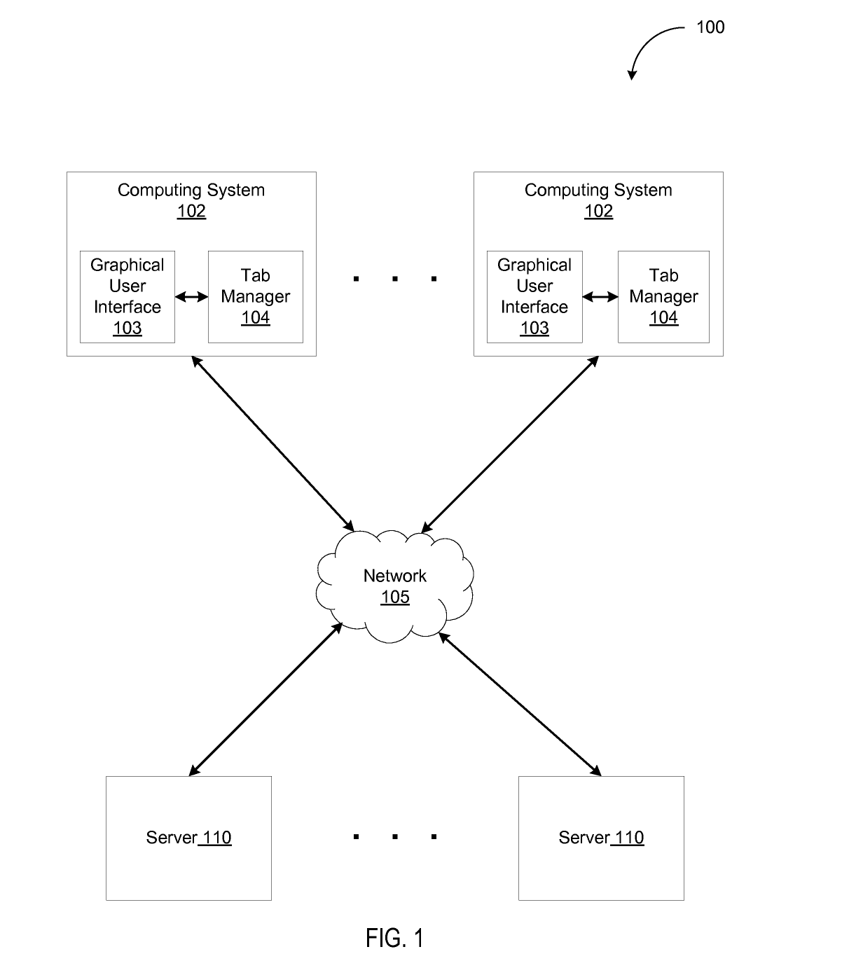

FIG. 1 illustrates an exemplary system architecture 100, in accordance with one embodiment of the present invention. System 100 includes computing systems 102 in communication with (e.g., coupled to) servers 110 over a network 105. Each computing system 102 includes a GUI 103 and a tab manager 104. In one embodiment, the network 105 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The servers 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. In one embodiment, the servers 110 may provide data (e.g., digital video, streaming video, images, digital music, streaming music, web pages, other data, etc.) and/or services to one or more of the computing devices 102. For example, the server 110 may provide video data for a streaming video requested by a user to the computing system 102 via the network 105. Similar to the servers 110, the computing systems 102 may also include computing devices that have a wide range of processing capabilities (e.g., a personal computer (PC), a personal digital assistant (PDA), a smart phone, a laptop computer, a netbook computer, a tablet device, a cellular phone, etc.).

As discussed earlier, each computing system 102 includes a GUI 103 and a tab manager 104. In one embodiment, the GUI 103 may be provided by an application executing on the computing system 102. For example, the GUI may be provided by a word processing application or a browser application to present data and/or receive user input. In another embodiment, the GUI 103 may be provided by an operating system on the computing system 102. For example the operating system of the computing system 102 may provide the GUI 103 to present data and/or receive user input (e.g., setting information) used by the operating system. In one embodiment, the GUI 103 may facilitate the receipt of user input and/or may facilitate the presentation of data (e.g., text, video, images, music, etc.) to the user. In another embodiment, the GUI 103 may include multiple portions, each portion of the GUI 103 presenting different user interface elements (e.g., tabs, tables, menus, text fields, buttons, drop down menu, tool bars, etc.)

In one embodiment, the GUI 103 may include one or more tabs. Each tab may provide for a logical grouping of data and/or other user interface elements. For example, a browser application may provide a GUI 103 with multiple tabs, each tab presenting a different webpage. In another embodiment, an application may provide a GUI 103 which includes a menu bar providing access to functions, options, settings, and other menu items for the application. Each of the menu items in the menu bar (e.g., “File,”, “Edit,” “View,” “Insert,” etc.) may be presented within a tab in the GUI 103. The menu bar may also be referred to as a file menu. In one embodiment, the tabs may be provided in a first portion of the GUI 103. In another embodiment, data associated with the tabs (e.g., other user interface elements, information related to the tabs, actions and/or options associated with the tab, settings associated with the tabs, menu item lists, etc.) may be provided in a second portion of the GUI 103. The data associated with the tabs (which is provided in the second portion of the GUI 103) may be referred to as context data associated with the tabs. In one embodiment, the user may select one of the tabs (e.g., via a mouse, keyboard, a motion sensing device to detect user gestures/movements, or a touch screen input) displayed in the first portion of the GUI 103. The selected tab may be highlighted, weighted, and/or emphasized in the GUI 103, in order to differentiate the selected tab from other tabs displayed in the first portion of the GUI 103.

In one embodiment, the GUI 103 may also provide a menu bar adjustment element (e.g., a user interface element such as a handle, or a drag bar) to adjust the size of the first portion where the tabs are provided.

In one embodiment, the tab manager 104 may adjust the size of the first portion of the GUI 103 based on a user input (e.g., based on a user activation of the menu bar adjustment element or handle). For example, the first portion of the GUI 103 may fully extend across a display screen (e.g., a liquid crystal display (LCD), a capacitive touch screen, a resistive touch screen, a light emitting diode (LED) screen, etc.) of the computing system 102. When a user activates the menu bar adjustment element (e.g., by clicking on or touching the element, by making a movement/gesture which is sensed by a motion sensing device, etc.) and slides the menu bar adjustment element, the tab manager 103 may adjust the size of the first portion of the GUI 103 (where the tabs are provided) based on the ending position of the menu bar adjustment element after the user adjusts the position of the menu bar adjustment element. In another embodiment, the tab manager 104 may also adjust the size of the second portion of the GUI 103 (e.g., where the contextual information associated with the tabs is provided), based on the user input. For example, the second portion of the GUI 103 may be located next to the first portion of the GUI 103. If the size of the first portion of the GUI 103 is reduced, the size of the second portion of the GUI 103 may increase, and vice versa.

In one embodiment, when the size of the first portion of the GUI 103 is adjusted, the tab manager 104 may also adjust the tabs which are displayed in the first portion of the GUI 103 such that the tabs fit within the first portion of the GUI 103. For example, the position of tabs may be adjusted such that the tabs overlap and/or the size of the tabs may be reduced, in order to fit the tabs within the new size of the first portion of the GUI 103. In another embodiment, when the tab manager 103 adjusts the tabs based on the change in the size of the first portion, a tab which is selected by a user (e.g., a selected tab) may be positioned within the first portion of the GUI such that the data presented in the selected tab (e.g., text, title, image, etc., within the tab) is not obscured.

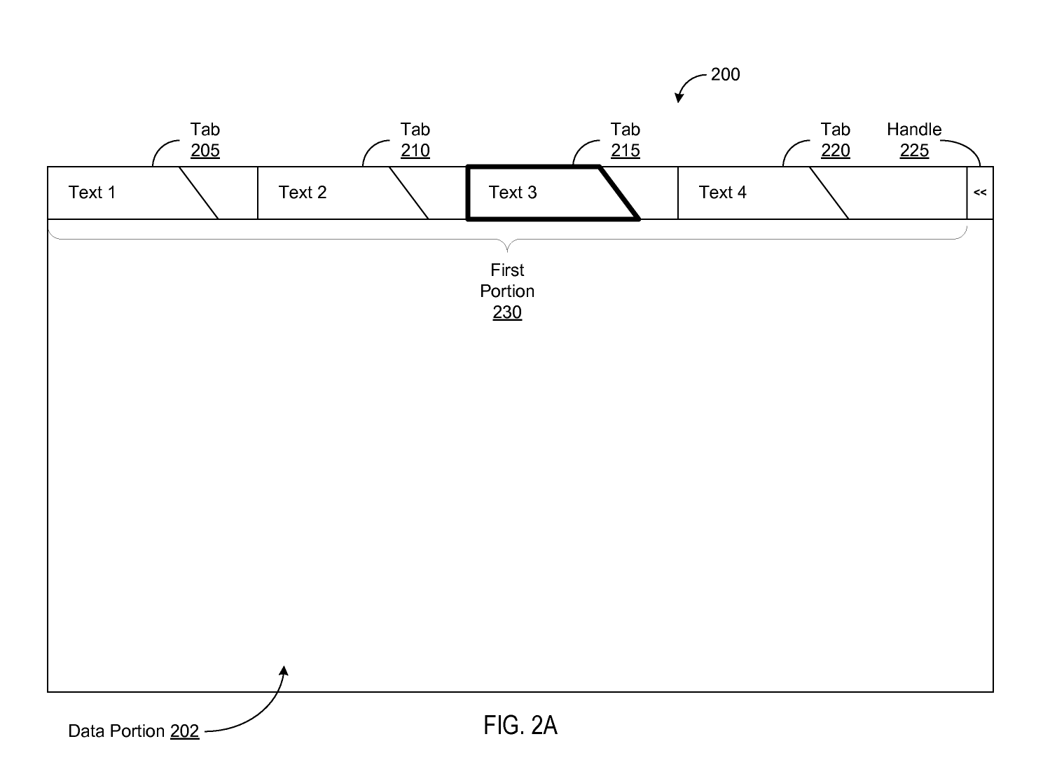

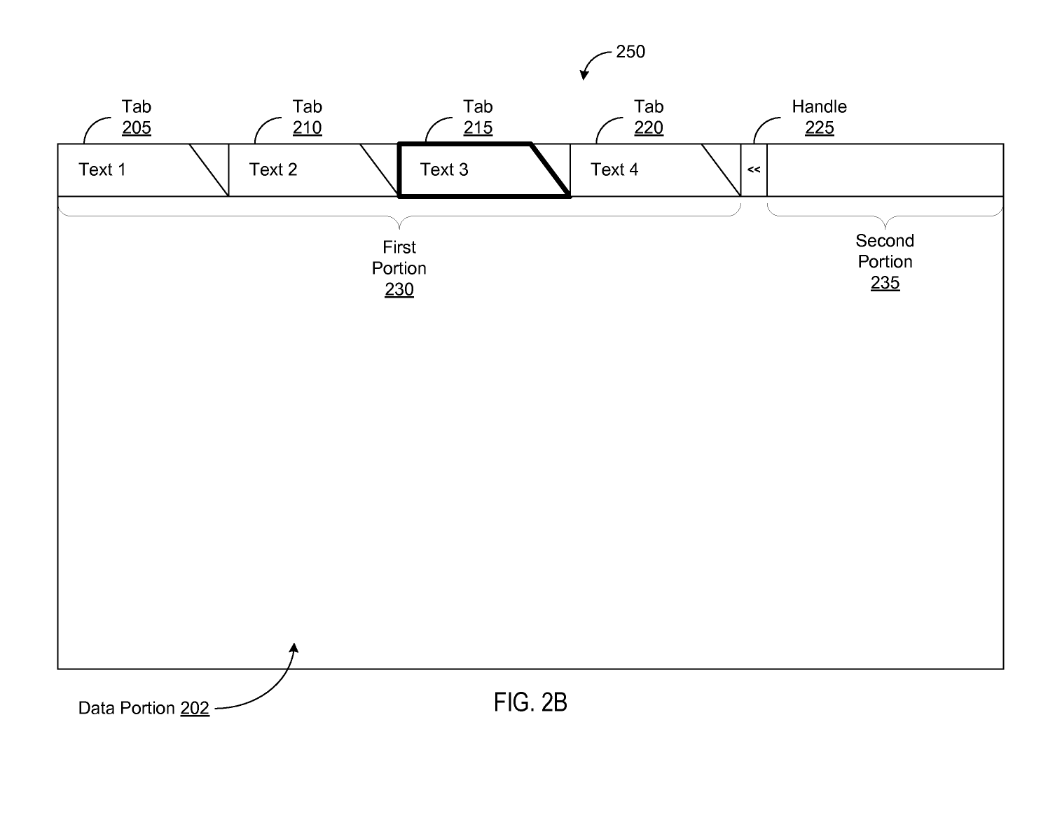

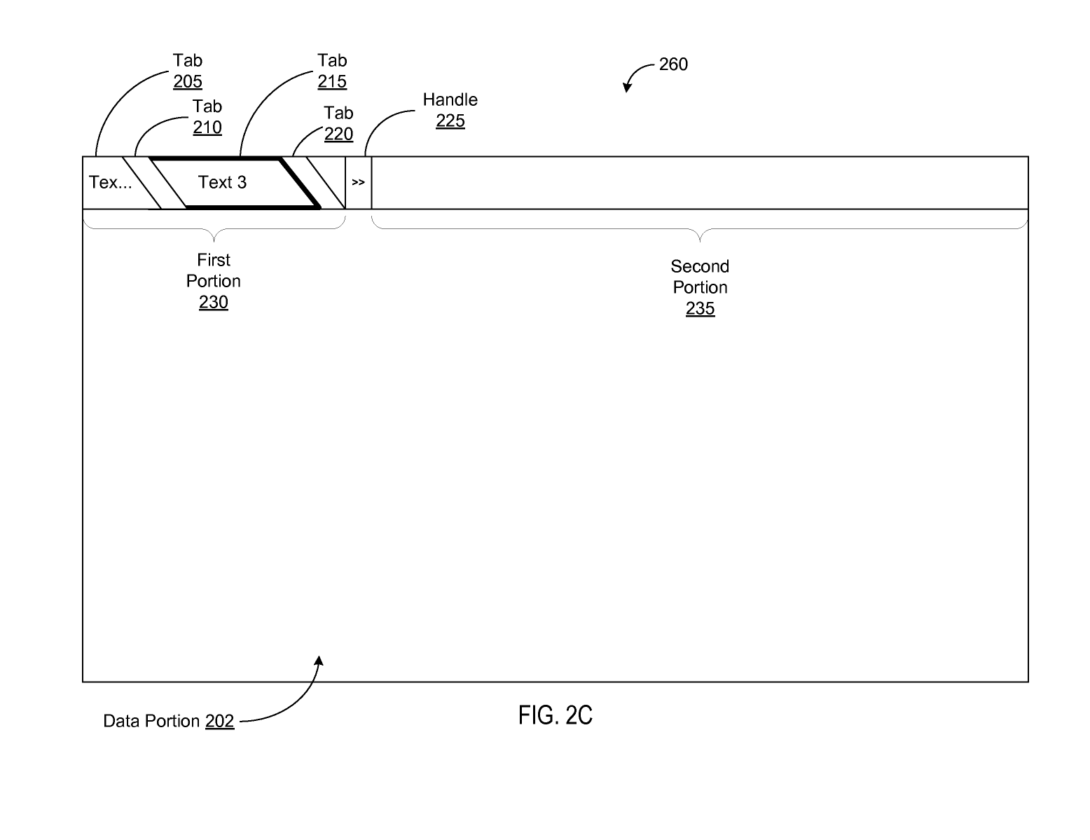

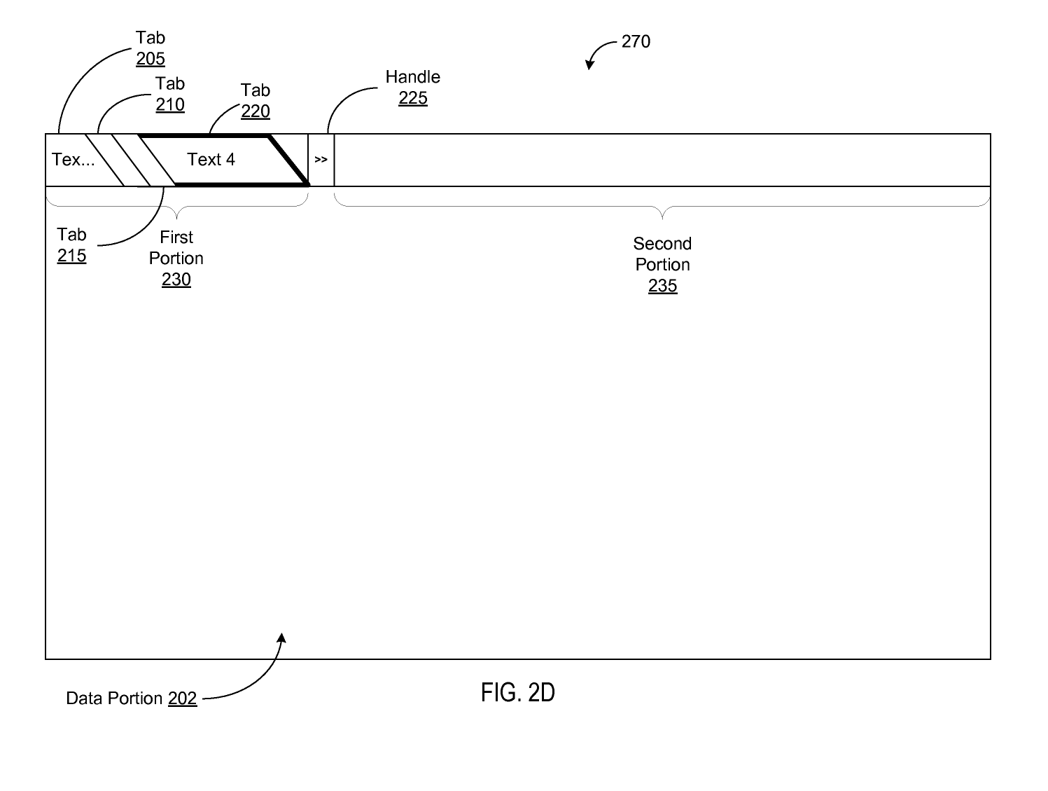

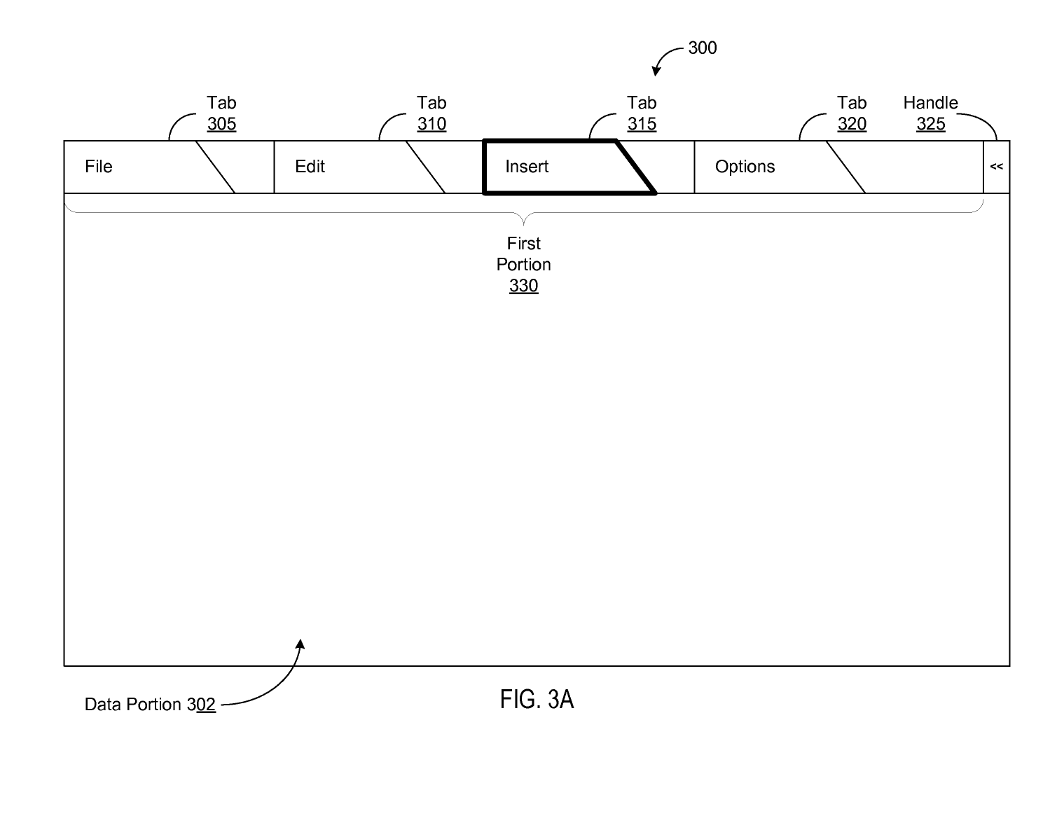

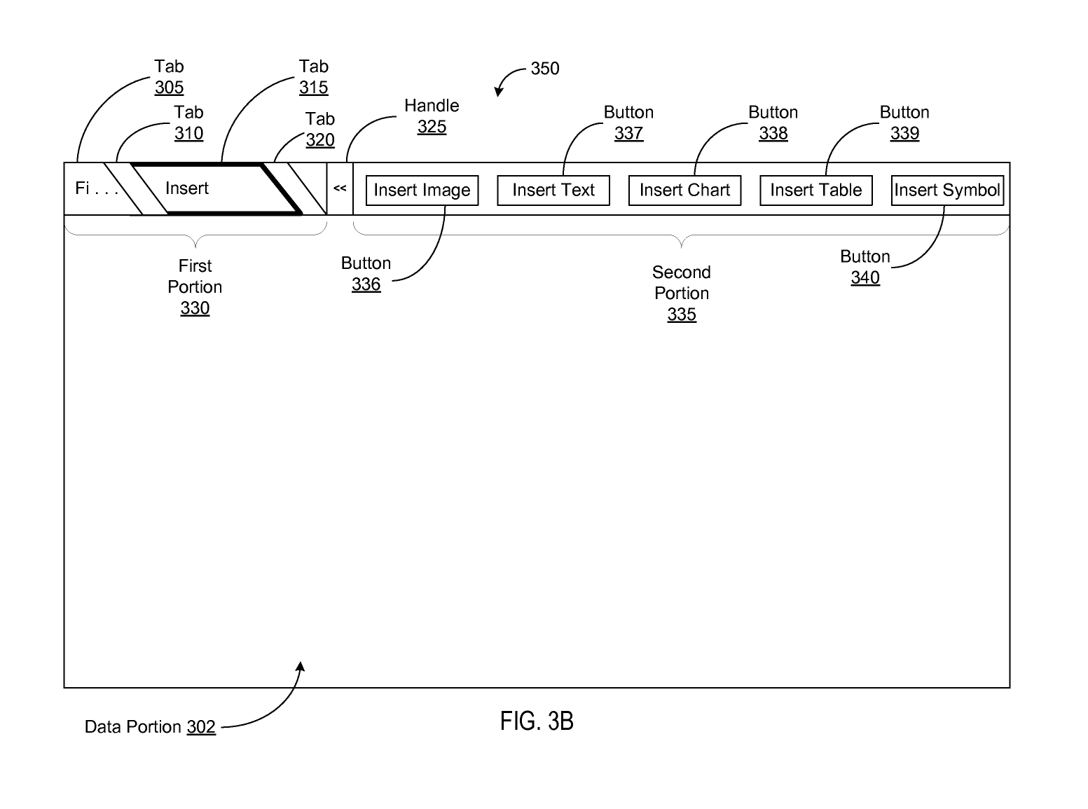

As discussed above, a display screen for the computing system 102 (e.g., a liquid crystal display (LCD), a capacitive touch screen, a resistive touch screen, a light emitting diode (LED) screen, etc.), may have smaller screen space (e.g., a 4-inch diameter screen) than that of a larger computing device (e.g., a laptop computer or desktop computer). Conventionally, a GUI 103 which presents data using tabs would use a portion of the screen space to display the tabs. Using the portion of the screen space to display the tabs decreases the amount of screen space which may be used to display other data. Embodiments of the present invention address this problem by reducing the amount of screen space occupied by tabs which are provided by the GUI 103. Exemplary GUIs, tabs, and portions of the GUIs are discussed in more detail below in conjunction with FIGS. 2A-3B.

FIG. 2A is an exemplary graphical user interface (GUI) in accordance with one embodiment of the present invention. The GUI 200 includes a data portion 202, tabs 205, 210, 215, and 220, and a handle 225. In one embodiment, content (e.g., text, video, images, music, etc.) may be presented to a user in the data portion 202. In another embodiment, the data portion 202 may also include user interface elements (e.g., buttons, slide bars, menus) to facilitate the presentation of the content to the user and to facilitate the receipt of user input from the user. The tabs 205, 210, 215, and 220 are positioned within the first portion 230 of the GUI 200. As discussed above, the tabs 205, 210, 215, and 220, may provide for a logical grouping of content and/or other user interface elements which may be presented in the data portion 202.

Tab 215 is a tab which has been selected by a user (e.g., a selected tab). Data associated with the selected tab 215 is presented in the data portion 202. In one embodiment, if a selection of another tab is received (e.g., a selection of tab 205 is received), data associated with the newly selected tab (e.g., newly selected tab 205) may be presented in the data portion 202. For example, if the GUI 200 is provided by a browser application, tab 215 may be associated with a first webpage and the first webpage may be presented in the data portion 202 if tab 215 is selected. If a selection of a different tab (e.g., tab 205) is received, the web page associated with the different tab (e.g., tab 205) is presented in the data portion 202. As shown in the figure, selected tab 215 is highlighted (e.g., emphasized) in order to differentiate the selected tab 215 from the other tabs. The highlighting of the selected tab 215 may allow a user to determine which tab the data presented in data portion 202, is associated with.

In another embodiment, each of the tabs 205, 210, 215, 220 may present different types of data in the data portion 202. For example, tab 205 may be associated with a web page, tab 210 may be associated with a media file (e.g., a movie file), and tab 215 may be associated with a document file (e.g., a Portable Document Format (PDF) file). As each tab is selected, the data associated with the tab (e.g., the web page, the media file, etc.) may be presented in the data portion 202 and the context data (e.g., options, actions, settings, menu item lists, and/or other data) associated with the tab may be presented in the second portion of the GUI 200 (not shown in the figure).

FIG. 2B is an exemplary GUI 250 in accordance with another embodiment of the present invention. The GUI 250 includes a data portion 202, tabs 205, 210, 215, and 220, and a handle 225. The tabs 205, 210, 215, and 220 are positioned within the first portion 230 of the GUI 250. As discussed above, context data (e.g., user interface elements, actions, options, settings, etc.) associated with the tabs may be displayed within the second portion 235 of the GUI 250.

Tab 215 is a tab which has been selected by a user (e.g., a selected tab). Data associated with the selected tab 215 is presented in the data portion 202. In one embodiment, context data associated with the selected tab 215 is also presented in the section portion 235. For example, if the GUI 250 is provided by a browser application, actions for the selected tab 215 (e.g., bookmark webpage button, print webpage button, etc.) may be presented in the second portion 235. In another example, if the GUI 250 may be provided by a media view application, the selected tab 215 may be associated with a media file (e.g., a movie) and actions for the media file (e.g., play, pause, fast forward, rewind, etc.) may be presented in the second portion 235.

As shown in the figure, a user input indicating an activation of the handle 225 (e.g., a menu bar adjustment element) is received. In one embodiment, the user input may include one or more of a keystroke, a mouse input, a user gesture/movement sensed by a motion sensing device, and/or a touch screen input. For example, the user may activate the handle 225 by tapping on the handle 225 via a touch screen. In another example, the user may activate the handle 225 by clicking on the handle using a mouse input device. In a further example, a user may wave his hand or perform a gesture using his arm to activate the handle 255. As compared to FIG. 2A, the handle 225 in FIG. 2B has been dragged towards the left end of the screen 250 from its original position in FIG. 2A. The size of the first portion 230 is reduced based on the change in the position of the handle 225. In addition, the size of the second portion 235 is increased when compared to FIG. 2A, where the second portion is not presented because the first portion 230 spans the width of the GUI 200 in FIG. 2A (e.g., the first portion 230 is maximized in FIG. 2A).

FIG. 2C is an exemplary GUI 260 in accordance with a further embodiment of the present invention. The GUI 260 includes a data portion 202, tabs 205, 210, 215, and 220, and a handle 225. The tabs 205, 210, 215, and 220 are positioned within the first portion 230 of the GUI 260. As discussed above, context data (e.g., user interface elements, actions, options, settings, etc.) associated with the tabs may be displayed within the second portion 235 of the GUI 260. Tab 215 is a tab which has been selected by a user (e.g., a selected tab). Data associated with the selected tab 215 is presented in the data portion 202. In one embodiment, context data associated with the selected tab 215 is also presented in the second portion 235.

As shown in the figure, a user input (e.g., keystroke, mouse input, a user gesture/movement sensed by a motion sensing device, and/or touch screen input) indicating an activation of the handle 225 (e.g., a menu bar adjustment element) is received. As compared to FIGS. 2A and 2B, the handle 225 has been dragged towards the left end of the screen 260 from its original position in FIG. 2A past the position shown in FIG. 2B. The size of the first portion 230 is reduced based on the change in the position of the handle 225. In addition, the size of the second portion 235 is increased when compared to FIGS. 2A and 2B.

In one embodiment, the first portion 230 may be “minimized” and the second portion 235 may be “maximized” due to the activation and movement of the handle 225. It should be understood that although the terms “minimized” and “maximized” are used to describe the size of the first portion 230 and the second portion 235, these terms do not necessarily mean that the sizes of the first portion 230 and the second portion 235 are at their maximum or minimum. The terms minimized and maximized may also refer to adjusting and/or modifying the sizes of first portion 230 and the second portion 235 to certain thresholds (e.g., size of the first portion 230 is less than 25% of the width of the GUI 260 and size of second portion 235 is greater than 75% of the width of the GUI 260). Increasing the size of the second portion 235 allows more data associated with the selected tab 215 to be presented within the second portion 235. This allows more data to be presented to a user when compared with previous types of user interfaces (where the size of the tabs could not be reduced to provide more space for the context data of the selected tab).

In one embodiment, selected tab 215 is sized and/or positioned such that the data presented by the selected tab 215 (e.g., text within the tab, an image or icon within the tab) is not obscured by the other tabs 205, 210, and 220. In another embodiment, the selected tab 215 is sized such that the data presented by the selected tab 215 is not obscured due to the size of the tab (e.g., the tab is sized such that the text is not cut off because the tab is too small to fit the text). This may allow a user to determine which tab the data presented in data portion 202, is associated with. For example, the user may be able to determine which webpage is associated with the selected tab 215 by reading the title of the selected tab 215, which is not obscured by the other tabs 205, 210, and 220. In a further embodiment, the size and/or position of different tabs (e.g., tabs 205, 210, or 220) may be adjusted when the different tabs are selected by a user (e.g., user input indicating a selection is received), such that the data presented within the different selected tabs is not obscured. Adjusting the size and/or position of the different tabs is discussed in more detail below, in conjunction with FIG. 2D.

FIG. 2D is an exemplary GUI 270 in accordance with another embodiment of the present invention. The GUI 270 includes a data portion 202, tabs 205, 210, 215, and 220, and a handle 225. The tabs 205, 210, 215, and 220 are positioned within the first portion 230 of the GUI 270. As discussed above, context data (e.g., user interface elements, actions, options, settings, etc.) associated with the tabs may be displayed within the second portion 235 of the GUI 270. Also, as discussed above the first portion 230 may be minimized and the second portion 235 may be maximized.

In FIG. 2D, a user input is received which indicates the selection of the tab 220. As compared to FIG. 2C, tab 215 was positioned such that the data presented in tab 215 (e.g., “Text 3”) was not obscured, because tab 215 was the previously selected tab. Referring back to FIG. 2D, tab 220 is the newly selected tab, as opposed to previously selected tab 215 shown in FIG. 2C. Tab 220 is positioned such that data presented within the tab 220 (e.g., “Text 4”) is not obscured, and tab 215 is minimized (e.g., tab 215 is repositioned and/or reduced in sized) such that all the tabs fit within the first portion 230. Tab 220 is also highlighted because tab 220 is the selected tab. Data associated with the selected tab 220 is presented in the data portion 202. In one embodiment, context data associated with the selected tab 220 is also presented in the second portion 235.

In one embodiment, the user input indicating selection of a different tab (e.g., tab 220) may be a touch screen input. For example, the user input may be a swipe gesture received from a touch screen display on a computing system. When the user swipes towards the left, the tab to the left of the current selected tab is selected. When the user swipes towards the right, the tab to the right of the current selected tab is selected. In another example, if the user waves his hands towards the left, a motion sensor may sense this movement and the tab to the left of the current selected tab is selected. When the user waves his hands towards the right, the tab to the right of the current selected tab is selected. This may allow a user to easily select the different tabs 205, 210, 220, and 230, without having to use the handle 225 to adjust the size of the first portion 230.

In one embodiment, the first portion 230 may automatically maximize (e.g., increase to the size shown in FIG. 2A) when a user input is received within the first portion 230. For example, the user may use a mouse input device and click within the first portion 230. In another example, the user may touch a portion of the touch screen where the first portion is displayed. Maximizing the first portion allows the user to see all of the different data presented in the different tabs. The user may then select a different tab. After receiving the user selection of the different tab, the first portion may automatically minimize and the newly selected tab may be positioned and/or sized such that data presented by the newly selected tab is not obscured. For example, referring back to FIG. 2C, tab 215 may be the originally selected tab and the data presented within tab 215 is not obscured. The user may touch a portion of the touch screen where the first portion 230 is displayed, and the first portion 230 may maximize (e.g., the size of the first portion 230 may increase) to the size shown in FIG. 2A. The user may then select tab 220 (e.g., by selecting tab 220 via a touchscreen). After receiving the user selection of tab 220, the first portion 230 may minimize (e.g., the size of the first portion 230 may decrease) to the size shown in FIG. 2D and tab 220 is positioned and/or sized such that the data presented within tab 220 is not obscured. The position and/or size of tab 215 are adjusted and the data presented within the tab 215 is obscured by the tab 220. In another embodiment, the first portion 230 may automatically minimize after a certain period of time (e.g., 5 seconds, 15 seconds, 1 minute, etc.) in which no user input is received (e.g., a period of inactivity).

FIG. 3A is an exemplary GUI 300 in accordance with one embodiment of the present invention. The GUI 300 includes a data portion 302, tabs 305, 310, 315, and 320, and a handle 325. In one embodiment, data (e.g., text, video, images, music, user interface elements, etc.) may be presented to a user in the data portion 302. The first portion 330 may be a menu bar (e.g., a menu which provides access to functions, options, actions, settings, and/or data) for an application. The menu items (e.g., File, Edit, Insert, etc.) are presented as tabs within the first portion 330 (e.g., within the menu bar). The tab 315 (e.g., the menu item “Insert”) is highlighted because the tab 315 is a tab selected by a user. The first portion 330 is maximized (e.g., the width of the first portion extends across the GUI 300).

FIG. 3B is an exemplary GUI 350 in accordance with another embodiment of the present invention. The GUI 300 includes a data portion 302, tabs 305, 310, 315, and 320, a handle 325, and buttons 336, 337, 338, 339, and 340. Data (e.g., text, video, images, music, user interface elements etc.) may be presented to a user in the data portion 302. The GUI 300 includes a menu bar, where the menu items are presented as tabs within the first portion 330.

The first portion 330 is minimized (e.g., the size of the first portion is reduced). The tab 315 (e.g., the menu item “Insert”) is highlighted because the tab 315 is a tab selected by a user. In addition, the text presented by the selected tag 315 (e.g., “Insert”) is not obscured because the tab 315 is the selected tab. Context data such as the buttons 336, 337, 338, 339, and 340 are presented in the second portion 335 of the GUI 350. As discussed above, context data may include, but is not limited to options, actions, settings, menu item lists, and/or other data, associated with the selected tab 315 (e.g., “Insert”). The buttons 335 through 340 may be the menu item list (e.g., the list of available actions or options, such as “Insert Image”) associated with the selected tab (e.g., the “Insert” menu item).

In one embodiment, the GUI 305 may provide a menu bar which can fit within the smaller screen sizes of mobile computing devices because the tabs which present the menu items for the menu bar may be adjusted to allow more space for the menu item lists (e.g., the buttons 336 through 340).

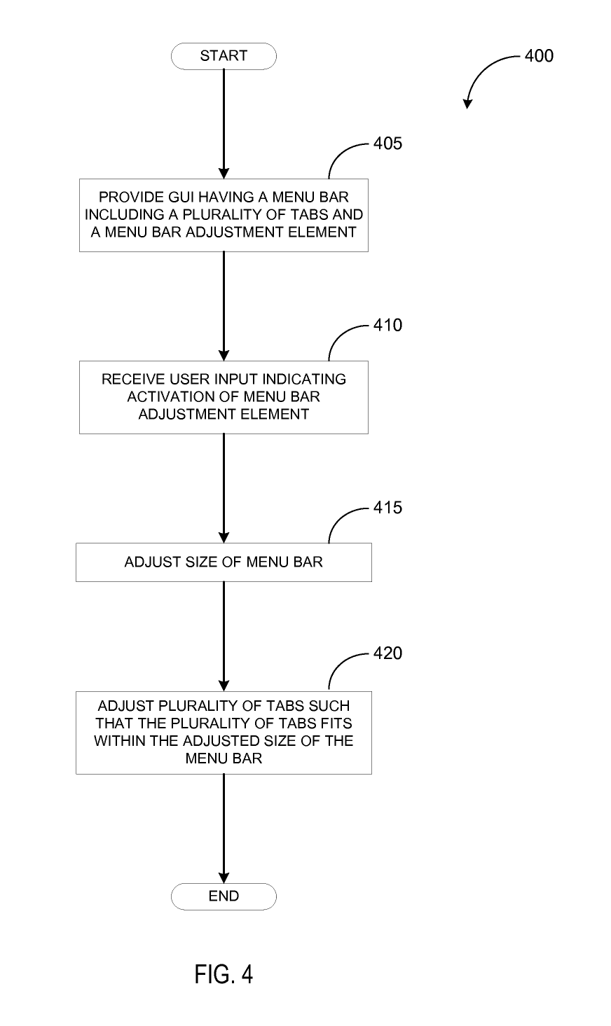

FIG. 4 is a flow diagram illustrating one embodiment for a method 400 of adjusting tabs provided by a GUI. The method 400 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 400 is performed by a computing system (e.g., the computing system 102 of FIG. 1).

Referring to FIG. 4, the method 400 starts at block 405 with the computing system providing a GUI having a menu bar including a plurality of tabs and having a menu bar adjustment element (e.g., GUI 300 in FIG. 3A). The plurality of tabs may include a tab which is selected by a user (e.g., selected by the user via a touchscreen input or selected by a user gesture/movement). In one embodiment, each of the tabs may be a menu item for the menu bar. At block 410, user input identifying an activation of a menu adjustment element (e.g., handle 325 in FIG. 3A) is received. The size of the menu bar (e.g., the first portion 330 in FIGS. 3A and 3B) is modified (e.g., increased or decreased) based on the user input at block 415. The plurality of tabs presented within the menu bar is adjusted such that the tabs fit within the adjusted size of the menu bar (block 420).

Although the method 400 refers to a menu bar, it should be understood that in other embodiments, the method 400 may be operable with any GUI which uses tabs (e.g., GUI 200 in FIG. 2A).

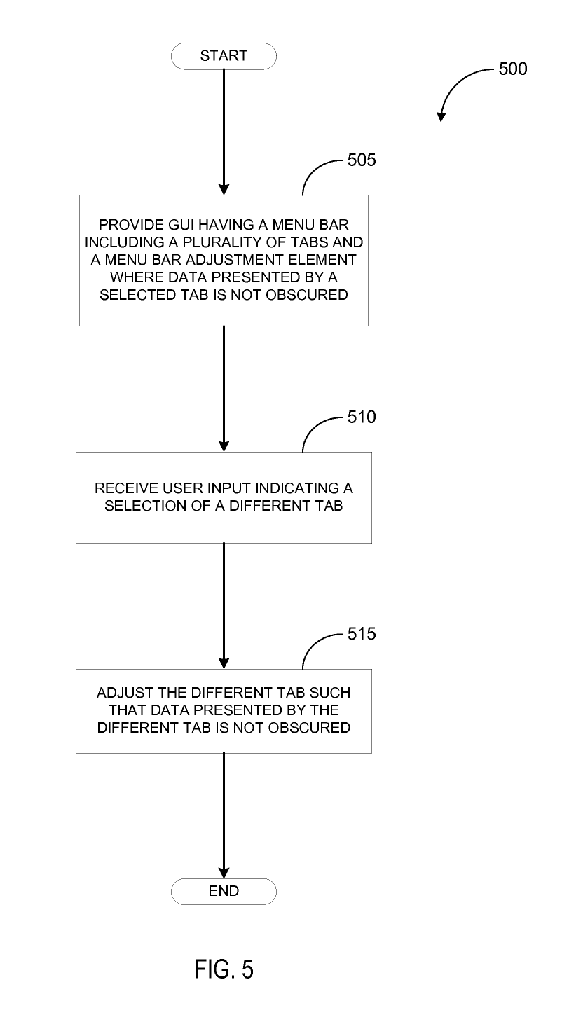

FIG. 5 is a flow diagram illustrating another embodiment for a method 500 of adjusting tabs provided by a GUI. The method 500 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 500 is performed by a computing system (e.g., the computing system 102 of FIG. 1).

Referring to FIG. 5, the method 500 starts at block 505 with the computing system providing a GUI having a menu bar including a plurality of tabs and having a menu bar adjustment element where data presented by a selected tab is not obscured (e.g., GUI 350 in FIG. 3B). At block 510, user input indicating a selection of a different tab is received. Based on the user input, the size and/or position of the different tab are adjusted such that data presented by the different tab is not obscured (block 515). For example, referring to FIG. 2C, tab 215 may be a previously selected tab and the data presented by tab 215 is not obscured. A user input selecting tab 220 may be received. Based on the user input, the size and/or position of tab 220 is adjusted, such that the data presented in tab 220 (e.g., “Text 4”) is not obscured, as shown in FIG. 2D.

Although the method 500 refers to a menu bar, it should be understood that in other embodiments, the method 500 may be operable with any GUI which uses tabs (e.g., GUI 200 in FIG. 2A).

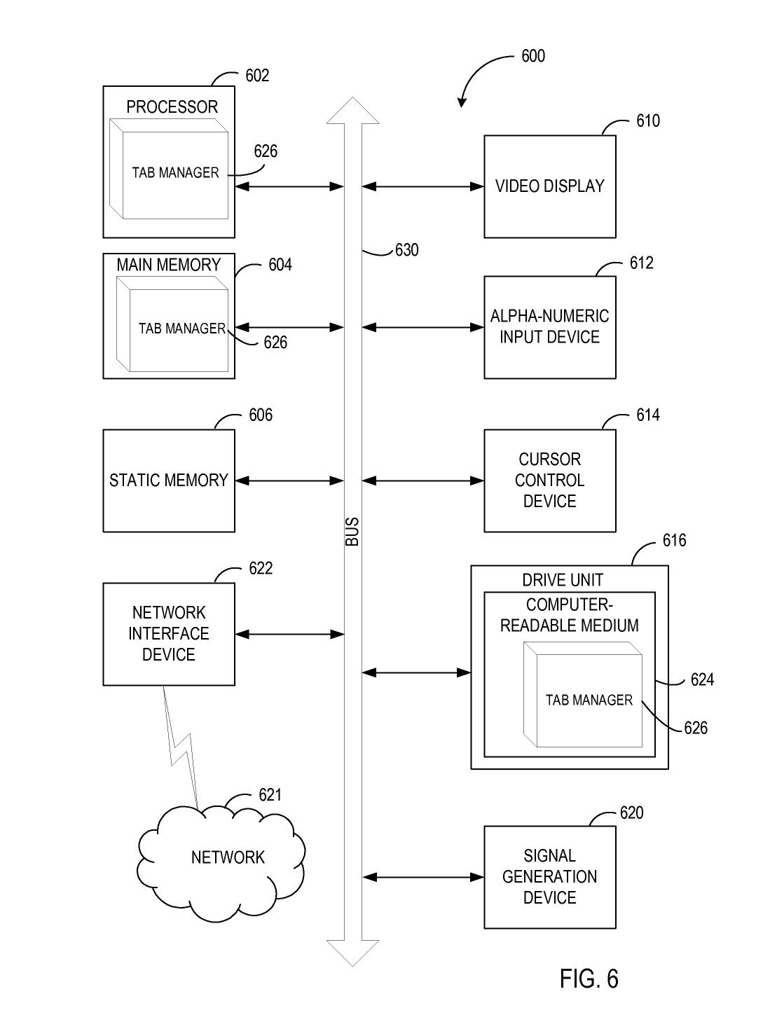

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a smart phone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device (processor) 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622 to communicate with a network 621. The computer system 600 also may include a video display unit 610 (e.g., a liquid crystal display (LCD), a touch screen, or a cathode ray tube (CRT)), an alphanumeric input device 612 (e.g., a keyboard), a cursor control device 614 (e.g., a mouse), and a signal generation device 620 (e.g., a speaker). The computer system 600 may also include a motion sensing device (not shown in the figures) to sense a user's gestures/movements (e.g., to sense movement of a user's arm).

The data storage device 616 may include a computer-readable storage medium 624 on which is stored one or more sets of instructions 626 (e.g., software) embodying any one or more of the methodologies or functions described herein. The instructions 626 may also reside, completely or at least partially, within the main memory 604 and/or within the processor 602 during execution thereof by the computer system 600, the main memory 604 and the processor 602 also constituting computer-readable storage media. The instructions 626 may further be transmitted or received over a network 621 via the network interface device 622.

In one embodiment, the instructions 626 include instructions for a tab manager, which may correspond to tab manager 104 of FIG. 1. While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “presenting,” “receiving,” “displaying,” “adjusting,” “modifying,” “selecting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method comprising:
providing, by a processing device, a graphical user interface comprising a menu bar, a tab context portion and a content portion, the menu bar having a plurality of tabs and a menu bar adjustment element, wherein one of the plurality of tabs comprises a selected tab that is visually differentiated from other tabs of the plurality of tabs, wherein the selected tab is associated with a video presented in the content portion, and wherein the tab context portion displays tab context data specifying a plurality of actions pertaining to playback of the video in the content portion corresponding to the selected tab;
receiving a first user input indicating an activation of the menu bar adjustment element; and
in response to the first user input:
reducing a size of the menu bar and adjusting the plurality of tabs to fit within the reduced size of the menu bar, wherein the selected tab remains visually differentiated from the other tabs of the plurality of tabs; and
increasing the size of the tab context portion to present additional actions pertaining to the playback of the video in the content portion corresponding to the selected tab.

2. The method of claim 1, wherein the selected tab is positioned to provide an unobscured view of data presented in the selected tab.

3. The method of claim 2, further comprising:
receiving a second user input selecting a different tab from the plurality of tabs; and
adjusting the plurality of tabs to provide an unobscured view of data presented in the different tab, based on the second user input.

4. The method of claim 1, wherein the plurality of actions in the tab context portion comprise one or more user interface elements associated with the content portions corresponding to the selected tab.

5. The method of claim 1, wherein the size of the menu bar is automatically reduced after selecting one of the plurality of tabs or after a period of inactivity.

6. The method of claim 1, wherein the graphical user interface is displayed within a screen of a smartphone, a personal digital assistance (PDA), or a cellular phone.

7. A system comprising:
a processing device configured to:
provide a graphical user interface comprising a menu bar, a tab context portion and a content portion, the menu bar having a plurality of tabs and a menu bar adjustment element, wherein one of the plurality of tabs comprises a selected tab that is visually differentiated from other tabs of the plurality of tabs, wherein the selected tab is associated with a video presented in the content portion, and wherein the tab context portion displays tab context data specifying a plurality of actions pertaining to playback of the video in the content portion corresponding to the selected tab;
receive a first user input indicating an activation of the menu bar adjustment element; and
in response to the first user input:
reduce a size of the menu bar and adjusting the plurality of tabs to fit within the reduced size of the menu bar, wherein the selected tab remains visually differentiated from the other tabs of the plurality of tabs; and
increase the size of the tab context portion to present additional actions pertaining to the playback of the video in the content portion corresponding to the selected tab.

8. The system of claim 7, wherein the selected tab is positioned to provide an unobscured view of data presented in the selected tab.

9. The system of claim 8, wherein the processing devices is further configured to:
receive a second user input selecting a different tab from the plurality of tabs; and
adjust that the plurality of tabs to provide an unobscured view of data presented in the different tab, based on the second user input.

10. The system of claim 7, wherein the plurality of actions in the tab context portion comprise one or more user interface elements associated with the content portions corresponding to the selected tab.

11. The system of claim 7, wherein the size of the menu bar is automatically reduced after selecting one of the plurality of tabs or after a period of inactivity.

12. The system of claim 7, wherein the graphical user interface is displayed within a screen of a smartphone, a personal digital assistance (PDA), or a cellular phone.

13. A method comprising:
providing, by a processing device, a graphical user interface comprising a plurality of tabs in a first portion of the graphical user interface and a tab adjustment element, the plurality of tabs comprising a tab selected by a user that is visually differentiated from other tabs of the plurality of tabs;
receiving a first user input indicating an activation of the tab adjustment element; and
in response to the first user input, modifying a size of the first portion of the graphical user interface and adjusting the plurality of tabs to fit within the modified size of the first portion of the graphical user interface, wherein adjusting the plurality of tabs to fit within the modified size of the first portion of the graphical user interface comprises increasing a size of the tab selected by the user, wherein the increased size of the tab selected by the user is larger than sizes of other tabs of the plurality of tabs and provides for an unobscured view of data within the tab selected by the user, wherein the tab selected by the user remains visually differentiated from the other tabs of the plurality of tabs.

14. The method of claim 13, further comprising:
receiving a second user input selecting a different tab from the plurality of tabs; and
adjusting the plurality of tabs to provide an unobscured view of the data presented by the different tab when the first portion is minimized, based on the second user input.

15. The method of claim 13, wherein the graphical user interface further comprises a context portion, wherein a size of the context portion is based on the modified size of the first portion, and wherein the context portion comprises one or more user interface elements associated with the tab selected by the user.

16. The method of claim 13, wherein the size of the first portion is automatically reduced after selecting one of the plurality of tabs or after a period of inactivity.

17. The method of claim 13, wherein the graphical user interface is displayed within a screen of a smartphone, a personal digital assistance (PDA), or a cellular phone.
